(19) United States
(12) Patent Application Publication
(10) Pub. No.: US 2009/0327965 A1
(43) Pub. Date: Dec. 31, 2009

(54) SELECTION OF ITEMS IN A VIRTUALIZED VIEW

(75) Inventors: Ashley Averett, Sammamish, WA (US); Benjamin Karas, Seattle, WA (US); Aaron Cardwell, Bellevue, WA (US)

Correspondence Address: MICROSOFT CORPORATION, ONE MICROSOFT WAY, REDMOND, WA, 98052-6399, US

(73) Assignee: MICROSOFT CORPORATION, Redmond, WA (US)

(21) Appl. No.: 12/147,669

(22) Filed: Jun. 27, 2008

(51) Int. Cl. G06F 3/048

(52) U.S. Cl. 715/835

(57) ABSTRACT

Disclosed herein is a system and method for selecting items or tiles when they are displayed using a virtualized display window. The system uses the row relative coordinates of each tile to determine whether those tiles were selected by the user. As the user scrolls or moves off of the originally displayed window, information related to the unrealized tiles that were once realized is stored so that selection of unrealized tiles is possible. Typically, the user will select tiles by indicating a starting point and drawing a rectangle to the desired ending point. Information related to the tiles that are intersected by the rectangle or enclosed in the rectangle are stored for use in the selection process in case those tiles are unrealized during the selection process. Once the tiles have been selected the user can perform operations on the selected tiles in a customary fashion.

### TECHNICAL FIELD

This description relates generally to selection of tiles or icons and more specifically to the selection of tiles and icons in a virtualized display window.

### BACKGROUND

The display of files and documents within a graphical directory structure will be familiar to users of operating systems such as Microsoft Windows, by Microsoft Corporation of Redmond Wash. In operating systems such as these the user accesses files, such as photos, through an application such as the Windows Explorer application. In these applications the users navigate to a desired directory location and when they reach the desired directory location all of the associated icons for the files are loaded and rendered into the window. Depending on the size of the directory and number of file icons that are to be displayed the process of rendering these images into the application can be time consuming. However, once the images have been loaded into the application the user can scroll or otherwise navigate through the directory. In some instances the user will desire to select a number of the files to perform an operation on (moving files, copying files, etc.). Typically, when selecting files the user draws a box around the files and this box indicates to the underlying application which files have been selected. Once the files have been selected the user performs the desired action on the group of files.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present example provides a system and method for selecting items or tiles when they are displayed using a virtualized display window. The system uses the row relative coordinates of each tile to determine whether those tiles were selected by the user. As the user scrolls or moves off of the originally displayed window, information related to the unrealized tiles that were once realized is stored so that selection of unrealized tiles is possible. Typically, the user will select tiles by indicating a starting point and drawing a rectangle to the desired ending point. In some embodiments this information is stored even when no scrolling occurs. Information related to the tiles that are intersected by the rectangle or enclosed in the rectangle are stored for use in the selection process in case those tiles are unrealized during the selection process. Once the tiles have been selected the user can perform operations on the selected tiles in a customary fashion.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a diagrammatic representation of a user interface according to one illustrative embodiment.

FIG. 2 is a close up of the display window according to one illustrative embodiment.

FIG. 3 is a close up of the display window following the scrolling of scrollbar.

FIG. 4 is a block diagram illustrating components of a selection system for use with a display window implementing virtualization according to one embodiment.

FIG. 5 illustrates an example of the starting of drawing a rectangle for selection according to one embodiment.

FIG. 6 illustrates an example of the ending of drawing a rectangle for selection according to one embodiment.

FIG. 7 is a flow chart describing an illustrative process used by the selection system in selecting tiles.

FIG. 8 is a block diagram illustrating a computing device which can implement the network state platform according to one embodiment.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

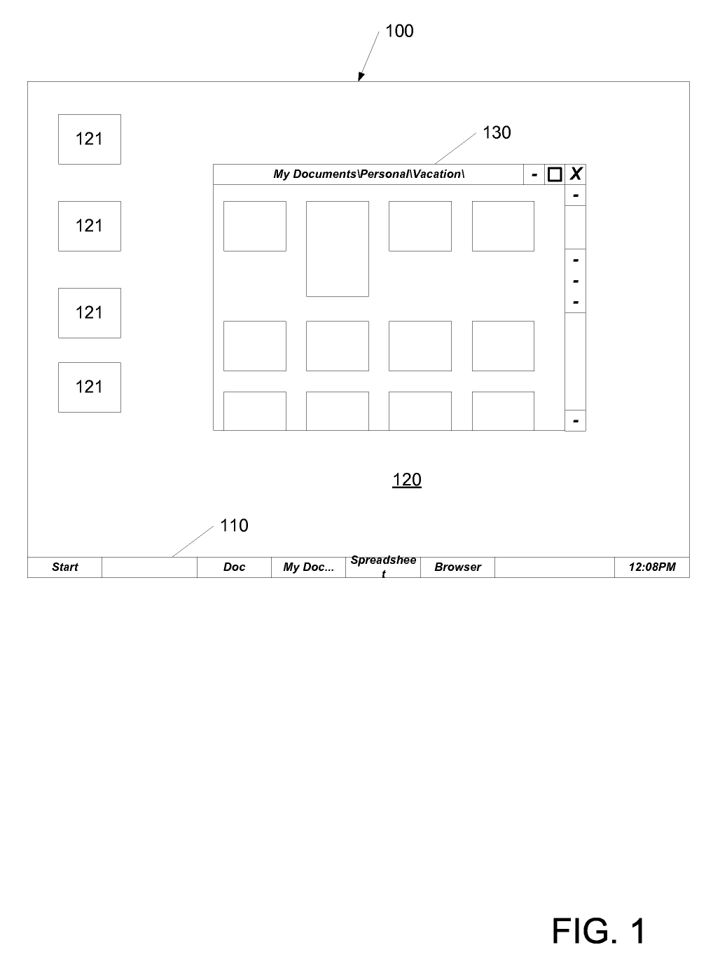

FIG. 1 is a diagrammatic representation of a user interface according to one illustrative embodiment. User interface 100 includes a task bar 110, a desktop 120 and at least one display window 130. The task bar 110 provides a user of the user interface 110 the ability to quickly access windows that are currently open in the user interface. The desktop 120 is a base display that the user experiences when the display is first presented. In some embodiments the desktop provides tiles or icons 121 that provide shortcuts for the user to access associated programs or files without the need to transit other methods to open the associated program or file.

Display window 130 is a display that includes a number of different tiles and/or icons that are representative of files, applications or folders. In contrast to traditional display windows the display window 130 of the present embodiments uses a virtualized list of the files for displaying the files. A more detailed description of this virtualization is discussed in more detail below. However, briefly in the virtualized list of the present embodiments, only that number of tiles that fit in the display window 130 are rendered into memory (or realized). The remaining tiles, i.e. the ones not visible in the display window 130, in the virtualized list are not rendered and removed from the memory (unrealized). As tiles need to become visible they are rendered and the tiles that are no longer visible are no longer rendered.

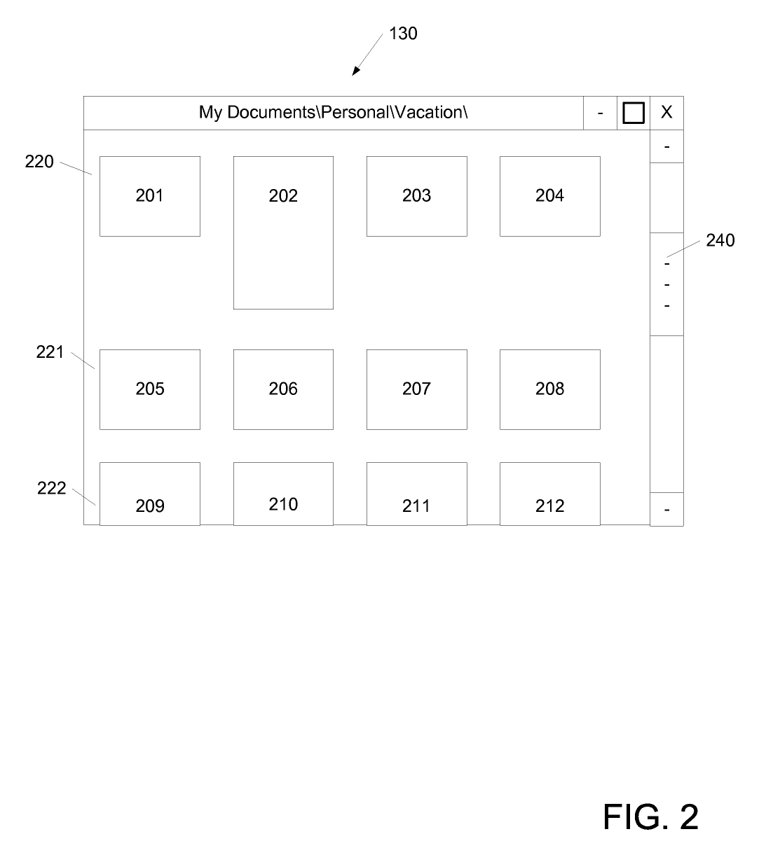

FIG. 2 is a close up of display window 130 introduced in FIG. 1 according to one illustrative embodiment. In this embodiment display window 130 is the Windows Explorer and allows for the displaying of a list of tiles or icons that are associated with a directory or other structure accessible by the application. Illustrated in display window 130 are a plurality of tiles 201-212, and may comprise a first set of tiles. Tiles 201-212 are representative of files such as photos, documents, spreadsheets, etc, applications, such as word processors, photo editors, internet browsers, etc, or folders. The tiles 201-212 are divided into a number of rows. In the embodiment illustrated in FIG. 2 the tiles are arranged in three rows, 220-222, where the bottom portion of the tiles of row 222 are not visible on the display window. Rows 220-222 are variable line height rows. That is the height of the rows are sized such that the largest tile in the row fits. In the example illustrated in FIG. 2 tile 202 is taller than the other tiles. Thus, row 220 has a row height that is larger than the row height of rows 221 and 222 which are illustrated having tiles of equal size. For example, row 220 may have a row height of 200 pixels and rows 221 and 222 may have a row height of 100.

Display window 130 has the ability to display more than tiles 201-212. Those tiles not displayed in display window 130 can be accessed through the use of a scroll bar 240. In contrast to current scroll bars that use the position of the scroll bar to determine which pixels will be visible at the top of the display window 130, the scrollbar 240 position is determined using a fractional line coordinates. The fractional line coordinates are then mapped to anchor and target variables to determine the position of the tiles on the display window 130.

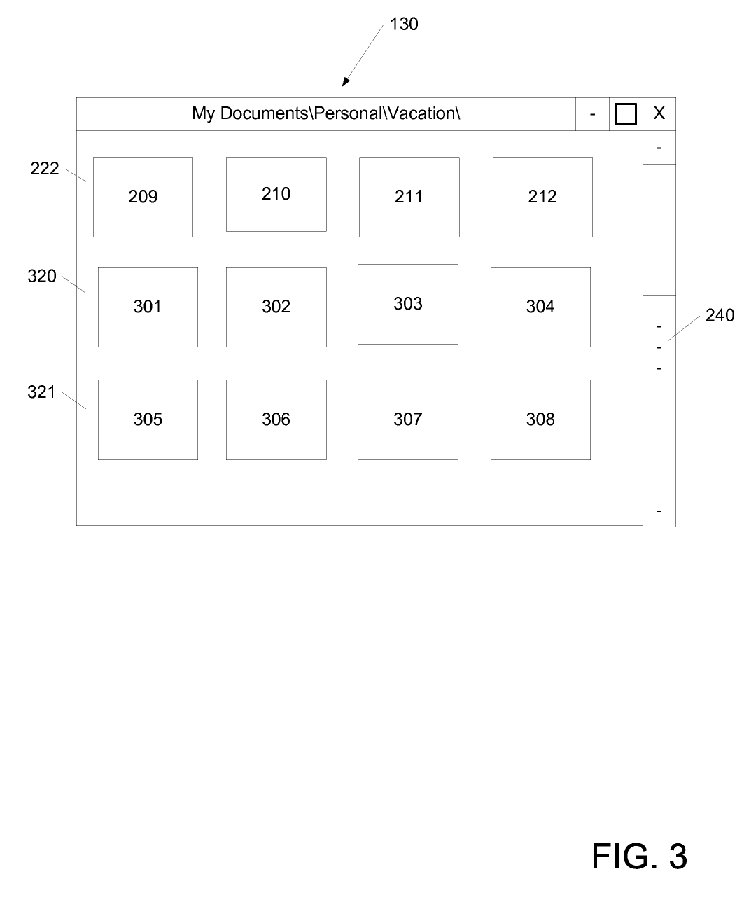

FIG. 3 is a close up of display window 130 following the scrolling of scrollbar 240. In FIG. 3 the scrollbar 240 has move down and now tiles of row 222 (FIG. 2) are now located at the top of the display window 130. Rows 320 and 321 are now visible and tiles 301-308 are now visible. Tiles 209-212 and 301-308 may comprise a second set of tiles. In some embodiments the second set of tiles can include tiles that were a part of the first set of tiles. As mentioned above in the present embodiments when rows 220 and 221 leave the area of display window 130, the associated tiles of these rows are no longer realized by the display. As these tiles are no longer realized by the displayed the information related to them is no longer available to the display window 130, until such time as these tiles are brought back into the display window 130 and are rendered again.

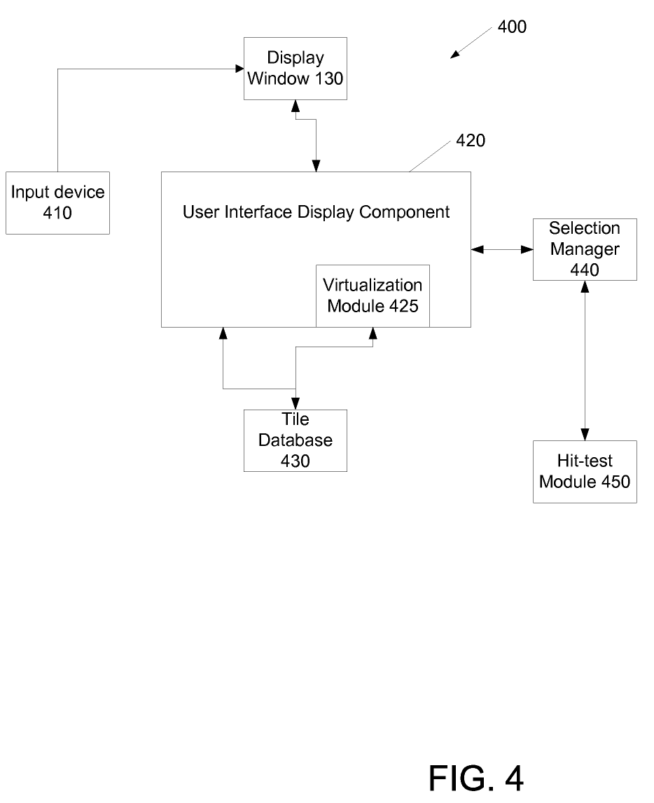

FIG. 4 is a block diagram illustrating components of a selection system 400 for use with a display window implementing virtualization according to one embodiment. Selection system 400 includes an input device 410, a UI display component 420, a tile database 430, a selection module 440 and a hit-test module 450. These components work together to allow the user of the system 400 to select tiles when the display window 130 is a virtualized window.

Input device 410 is a component of a computer system that allows the user to select or point on the user interface. In one embodiment the input device 410 is a pointing device, such as mouse or electronic pen. However, other types of input devices or methods can be used to allow the user to select points within the display window 130.

The user interface display component 420 is component or module of the system 400 that manages how the display window 130 and its contents are displayed on the user interface. User interface 420 includes a virtualization module 425. The virtualization module 425 obtains from the tile database 430 information related to the tiles that are to be displayed on the display window 130. This information includes at least, in one embodiment, the size of each tile that is associated with the display window. Based on the size of the tiles and the number of the tiles that are to be displayed in the display window 130 the virtualization module 425 determines the arrangement of the tiles in the display window 130. In one embodiment, the virtualization module uses a predetermined width of the display window 130. This predetermined width of the display window 130 assists the virtualization module 425 in arranging and determining the location of the tiles in the display window 130. In an alternative embodiment, the virtualization module uses a predetermined height for the display window 130. However, for purposes of this discussion it will be assumed that the virtualization module 425 is using a predetermined width for the display window.

The virtualization module uses the size of the tiles along with the predetermined width to arrange the tiles. This predetermined width is generally expressed in terms of pixels. However, other methods for defining the width of the display window can be used. The virtualization module 425 determines how many tiles can be placed in the display window 130 based on the size of the tiles. First the virtualization module identifies the width of each tile in the tile database 230 for the display window 130. Using these widths the virtualization module 425 determines the number of tiles that can fit within a row. Next the virtualization module 235 determines the height of each tile assigned to a row. The row height is then assigned based on the tallest tile in the group. In one embodiment the tiles are arranged such that the top of each tile in the row is at the same relative line height for the row. If the tiles are not of the same height a jagged bottom is seen by the user on display 130. An example of the jagged bottom is illustrated in FIG. 2 above. Similarly, if tiles are not of the same width a jagged width may appear in the window 130. Finally the virtualization module 425 assigns each tile in the display window a row and a column within the row. This information is stored for retrieval as the display window 130 is used.

Tile database 230 is a database that stores data related to tiles in display window 130. In one embodiment, each level within a display window has a separate table within the database. Alternatively the tiles that are displayed in a given display window are identified by a window identifier in the database. Data stored in database 230 for each tile, can include, the size of the tile to be displayed, an icon or image associated with the tile, a link to the content represented by the tile, a unique identifier for the tile. However, other information related to the tile may also be included in tile database 230.

When the user interacts with display window 130 to navigate through the various tiles of the display window, a signal is passed from the window 130 to the user interface display component 420. When the window is first opened the UI display component 420 determines the viewing size of the window. This information is passed to the virtualization module 425 which determines how many rows can be displayed in the current window configuration. The virtualization module 425 uses the stored row heights in this determination. Once the number of rows that can be displayed on the display window 130 have been determined, the virtualization module 425 communicates with the tile database 430 and renders the determined tiles according to the row/column arrangement discussed above. As this is the first rendering of the tiles, the scroll bar is disposed at the top of the window and the first set of rows are displayed. Those tiles associated with rows that are not currently in view are not rendered, or otherwise available in memory.

The user can then scroll through the display window to see the rows that are not currently visible. As the user scrolls the user interface display component receives indications as to the location of the scroll bar and passes this information to the virtualization module. The virtualization module uses this information to determine what rows are visible given the scroll bar position. Based on this determined position of the scroll bar the virtualization module obtains from the tile database the tiles that are now visible, and causes those tiles to be rendered on the display window 130, as discussed above. Further, the virtualization module removes or deallocates those tiles which are no longer visible in the display window.

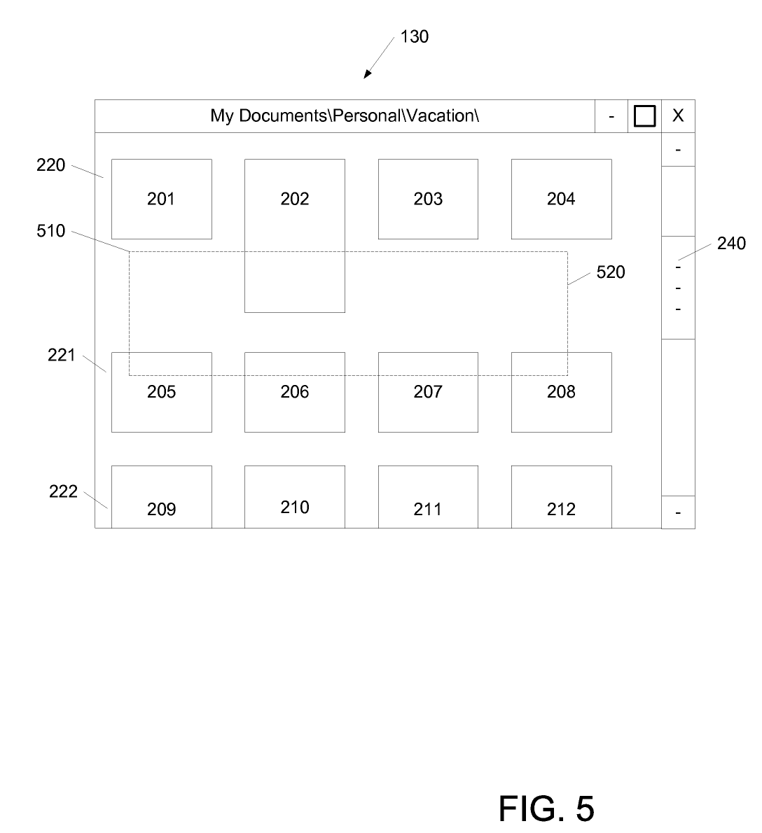

Selection manager 440 is a component of the system 400 that manages the selection of tiles in the display window 130 according to one embodiment. The selection manager 440 determines which tiles the user has selected when the user, for example draws a rectangle around tiles in the display window 130. FIG. 5 illustrates an example of the starting of drawing a rectangle for selection according to one embodiment. FIG. 5 is similar to FIG. 2 above and like numerals refer to like elements. To determine which tiles have been selected the selection manager receives a row-relative coordinate of the starting point 510 of rectangle 520. In some embodiments this may be executed by a separate component of the selection manager such as a marquee select subcomponent. The row relative coordinate includes the row that the starting point is located in, the vertical offset (e.g. in pixels) from the top of the row, and the horizontal offset (e.g. in pixels). In the embodiment illustrated in FIG. 5 a portion of rectangle 520 is drawn such that only some of the tiles in row 220 are intersected by the rectangle 520. The row relative coordinates are passed to the hit-test module 450.

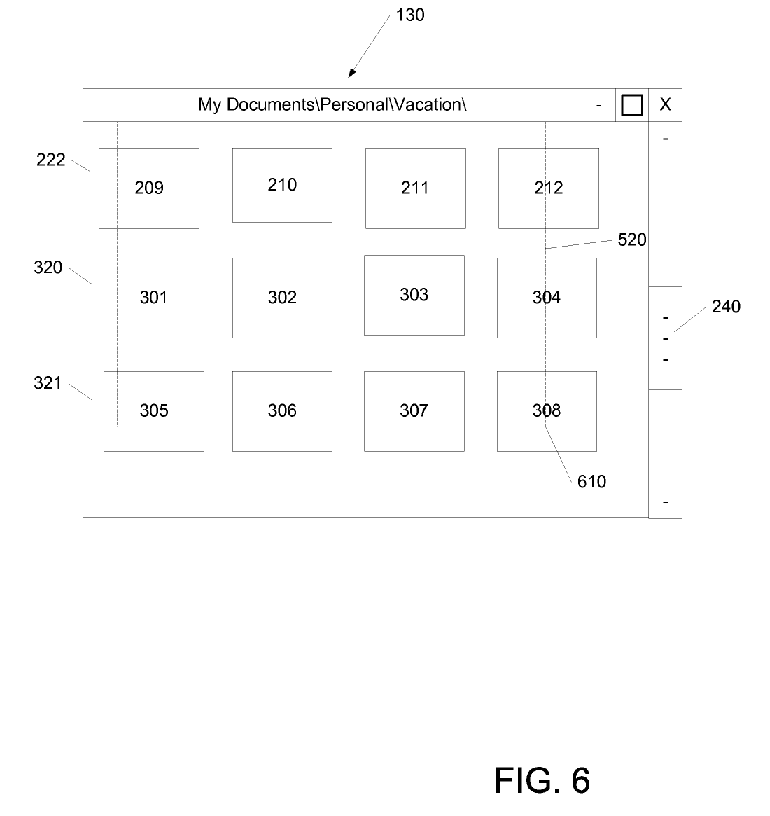

The hit-test module 450 is a module that determines whether a specific tile falls within the drawn rectangle. The hit-test module 450 performs a vertical hit-test against each tile in a given row. The vertical hit-test determines which tiles in the row can be intersected by the rectangle 520. In particular the hit-test module determines whether each tile is above, below or inside the vertical component of the row relative coordinate of the starting point 510. A similar operation is performed on the tiles of the row associated with the ending point 610 (FIG. 6). It should be noted that in the embodiments discussed herein, the starting point 510 and the ending point 610 are the diagonal opposite corners of the rectangle 520. (i.e top right and bottom left corners or vice versa). The horizontal component of the row relative coordinate for the starting and ending points is used to determine if tiles on interviewing rows between the starting and ending points are selected by the rectangle 520. The result of the hit-test is then returned to the selection manager 440, which adds to a list of selected tiles those tiles that are identified as having at least a portion of the tile within the rectangle 520. In some embodiments the hit test results are stored with the row relative coordinates for future use.

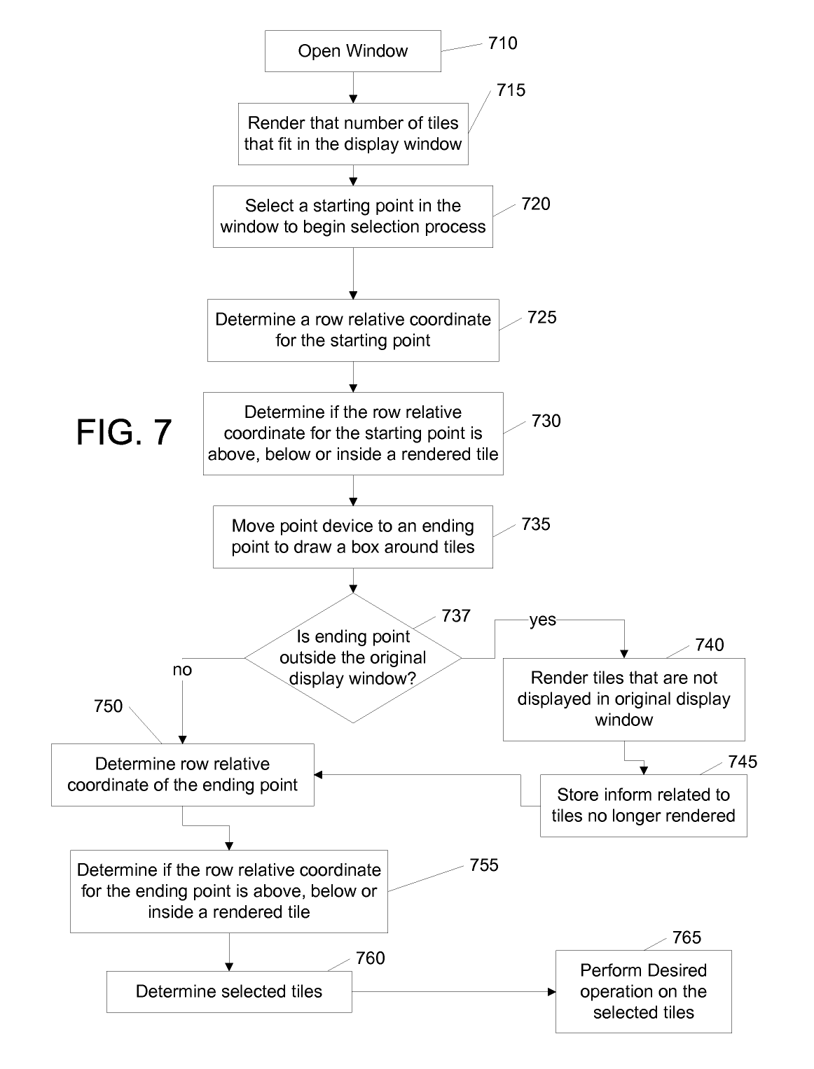

FIGS. 5 and 6 are close ups of display window 130 illustrating the process of selecting tiles according to one embodiment. FIGS. 5 and 6 are similar to FIGS. 2 and 3 with the addition of the selection rectangle 520. FIG. 7 is a flow chart describing an illustrative process used by system 400 in selecting tiles.

At step 710 the user opens display window 130. For example the user may open Windows Explorer or other graphical file navigation system. However, in some embodiments the opening of display window 130 may simply be moving from one level to another within the associated application.

Once the window is opened the user interface display component 420 and the virtualization module 425 determines the tiles that can be displayed in display window 130. As shown in FIG. 5, the virtualization module 425 determines that tiles 201-212 can be displayed in the display window 130. Thus, the user interface display component 420 communicates with the tile database 430 and causes the tiles to be rendered or realized in the display window 130. This is illustrated at step 715.

Following the rendering of the tiles 201-212 in display window 130, the user may desire to select some of the tiles displayed in the window 130. For example the user may desire to copy the tiles to another location or to delete these tiles from the system. In order to achieve this selection, in one embodiment, the user uses the pointing device 410 to select a starting point 510 and begins to draw a rectangle 520 that includes the tiles the user desires to select. This is illustrated at step 720.

Once the starting point 510 is selected, system 400 through the selection manager 440 determines the row-relative coordinates of the starting point. This is illustrated by step 725. Once the row-relative coordinates are determined, the selection manager 440 passes the row relative coordinates to the hit-test module 450, which determines the locations of the tiles relative to the starting point 510. In one embodiment the hit-test module determines if the tiles are above, below or inside the vertical component of the row relative coordinate. This is illustrated at step 730 In the embodiment illustrated in FIG. 5 only tile 202 is determined to be inside the row relative coordinate of the starting point. Tiles 201, 203 and 204 are determined to be above the row relative coordinate.

Next the user moves the pointing device 410 to an ending point 610. The ending point 610 is in one embodiment the opposite corner from the starting point 510 when the rectangle 520 is formed. As the user moves the pointing device 410, they may be presented with a rectangle 520 that allows them to see what tiles will be selected by the rectangle 520. The moving of the pointing device 410 to the ending point 610 is illustrated at step 735. At step 737 the virtualization module 425 determines if the user is moving the ending point 610 outside of the original window display. In other words, is the user attempting to include tiles that are not currently realized. If the user is attempting to select un-realized tiles, the virtualization module 425 renders the new tiles as was discussed above. This is illustrated at step 740. FIG. 6 illustrates the movement of the ending point 610 from FIG. 5 to include tiles 301-308, while unrealizing tiles 201-208.

As tiles that were previously realized are no longer visible, those tiles are no longer rendered in the system. However, in order to maintain information related to the selected tiles that are no longer rendered the selection manger 440 retains some information related to these tiles. In one embodiment, the selection manager 440 retains the tile's ID and its horizontal row relative coordinates. This information allows the selection manger 440 and the hit-test module 450 to determine if the tiles are unselected if the user moves the ending point 610 without having to realize or render those tiles again. The process of remembering and storing these unrealized tiles is illustrated at step 745.

At step 750 the row relative coordinates for the ending point 610 are determined. At step 755 the system 400 determines the location of the tiles associated with the row associated with the row relative coordinate of the ending point 610. This process is similar to steps 730 and 735 above. In the embodiment illustrated in FIG. 6 tiles 305-308 are determined to be inside the row relative coordinate of the ending point 610.

Once the starting and ending points have been determined by the user, the selection manger 440 determines which tiles are inside the rectangle 520 and have thus been selected by the user. This is illustrated at step 760. At this step the selection manager 440 determines the relationship between the starting point 510 and the ending point 610 to determine if the tiles above/below the row relative coordinate should be selected. The selection manager 440 also determines based on the horizontal component of the row relative coordinate which tiles in rows falling between are also included in the selection. Once the selection manager 440 determines which tiles are selected, the user performs the desired operation at step 765.

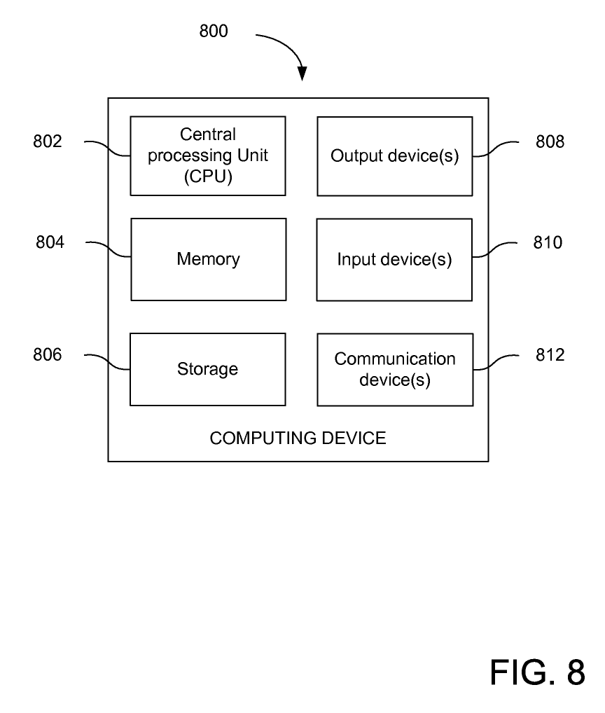

FIG. 8 illustrates a component diagram of a computing device according to one embodiment. The computing device 800 can be utilized to implement one or more computing devices, computer processes, or software modules described herein. In one example, the computing device 800 can be utilized to process calculations, execute instructions, receive and transmit digital signals. In another example, the computing device 800 can be utilized to process calculations, execute instructions, receive and transmit digital signals, receive and transmit search queries, and hypertext, compile computer code, as required by the system of the present embodiments.

The computing device 800 can be any general or special purpose computer now known or to become known capable of performing the steps and/or performing the functions described herein, either in software, hardware, firmware, or a combination thereof.

In its most basic configuration, computing device 800 typically includes at least one central processing unit (CPU) 802 and memory 804. Depending on the exact configuration and type of computing device, memory 804 may be volatile (such as RAM), non-volatile (such as ROM, flash memory, etc.) or some combination of the two. Additionally, computing device 800 may also have additional features/functionality. For example, computing device 800 may include multiple CPU's. The described methods may be executed in any manner by any processing unit in computing device 800. For example, the described process may be executed by both multiple CPU's in parallel.

Computing device 800 may also include additional storage (removable and/or non-removable) including, but not limited to, magnetic or optical disks or tape. Such additional storage is illustrated in FIG. 8 by storage 806. Computer storage media includes volatile and nonvolatile, removable and non-removable media implemented in any method or technology for storage of information such as computer readable instructions, data structures, program modules or other data. Memory 804 and storage 806 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 800. Any such computer storage media may be part of computing device 800.

Computing device 800 may also contain communications device(s) 812 that allow the device to communicate with other devices. Communications device(s) 812 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer-readable media as used herein includes both computer storage media and communication media. The described methods may be encoded in any computer-readable media in any form, such as data, computer-executable instructions, and the like.

Computing device 800 may also have input device(s) 810 such as keyboard, mouse, pen, voice input device, touch input device, etc. Output device(s) 808 such as a display, speakers, printer, etc. may also be included. All these devices are well known in the art and need not be discussed at length.

Those skilled in the art will realize that storage devices utilized to store program instructions can be distributed across a network. For example a remote computer may store an example of the process described as software. A local or terminal computer may access the remote computer and download a part or all of the software to run the program. Alternatively the local computer may download pieces of the software as needed, or distributively process by executing some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

1. A system for selecting tiles on a user interface comprising:
a display window configured to display a first set of tiles, the first set of tiles comprising only that number of tiles of a plurality of tiles that can be viewed in a viewing frame of the display window;
a virtualization module configured to render the first set of tiles;
a tile database configured to provide the virtualization module images of the first set of tiles; and
a selection manager configured to determine which of the plurality of tiles have been selected.

2. The system of claim 1 further comprising:
a pointing device configured to interact with the display window to view a second set of tiles in the plurality of tiles, the second set of tiles including at least a portion of the plurality of tiles that are not rendered, the pointing device further configured to indicate a starting point and an ending point of the selection.

3. The system of claim 2 wherein the virtualization module is configured to render the second set of tiles and to obtain images of the second set of tiles from the tile database.

4. The system of claim 2 wherein the display window displays a selection rectangle, the selection rectangle illustrating an area to be selected.

5. The system of claim 4 wherein the selection rectangle is defined by the starting point and ending point, the starting and ending points defining opposite vertexes of a diagonal defining the selection rectangle.

6. The system of claim 2 wherein the display window is divided into a plurality of rows having a fixed width.

7. The system of claim 2 wherein the display window is divided into a plurality of columns having a fixed height.

8. The system of claim 6 wherein the selection manager is configure to determine a row relative coordinate of the starting point and a row relative coordinate of the ending point.

9. The system of claim 8 further comprising:
a hittest module configured to determine if a tile in one of the plurality of rows has been selected.

10. The system of claim 9 wherein the hittest modules is further configured to determine if the tile in one of the plurality of rows is above, below or inside the row relative coordinate of the starting point, and to determine if the tile in one of the plurality of rows is above, below or inside the row relative coordinate of the ending point.

11. The system of claim 2 wherein when the second set of tiles is rendered in the display window those tiles that are in the first set of tiles and not in the second set of tiles are no longer rendered; and
wherein the selection manager is further configured to store information related to the location of the tiles in the first set that are no longer rendered relative to the starting and ending points.

12. A method for selecting items in a user interface comprising:
rendering a first set of tiles, the first set of tiles comprising only that number of tiles that can be displayed in the user interface;
indicating a with a pointing device a starting point for graphically selecting a portion of the tiles currently rendered in the user interface;
moving the pointing device to an ending point on the user interface, where the ending point is a point that is not visible on the user interface when the starting point is visible;
rendering a second set of tiles, the second set of tiles including at least a number of tiles that become visible as the pointing device moves from the starting point to the ending point; and
selecting those tiles that fall between the starting point and the ending point.

13. The method of claim 12 wherein moving the point device to the ending point further comprises:
drawing a rectangle on the user interface, the rectangle indicative of an area of selection.

14. The method of claim 12 further comprising:
calculating a row relative coordinate for the starting point; and
calculating a row relative coordinate for the ending point.

15. The method of claim 14 further comprising:
determining if a tile is above, below or inside the row relative coordinate for the starting point; and
determining if a tile is above, below or inside the row relative coordinate for the ending point.

16. The method of claim 15 wherein selecting the tiles that fall between the starting point and the ending point further comprises:
when the starting point is above the ending point, selecting those tiles that are below or inside the row relative coordinate for the starting point and selecting those tiles that are above or inside the row relative coordinate for the ending point; and
when the starting point is below the ending point, selecting those tiles that are above or inside the row relative coordinate for the starting point and selecting those tiles that are below or inside the row relative coordinate for the ending point.

17. The method of claim 12 wherein rendering the tiles comprises:
displaying the tiles in a plurality of rows, each of the plurality of rows having a fixed width
determining a number of tiles that can be displayed in each row;
determining a height for each of the plurality of rows, based upon the tiles to be displayed in that row.

18. The method of claim 12 further comprising:
storing information related to the location of at least a portion of the tiles in the first set of tiles when the at least a portion of the tiles are no longer rendered in the user interface.

19. The method of claim 18 further comprising:
moving the ending point to a new ending point; and
reselecting those tiles that fall between the starting point and the new ending point without rendering the at least a portion of the tiles.
